(19) United States
(12) Patent Application Publication
(10) Pub. No.: US 2004/0017150 A1
(43) Pub. Date: Jan. 29, 2004

(54) Apparatus for illuminating a probe plate to be examined

(76) Inventors: Christian Fricke, Dachau (DE); Jens-Christian Holst, Berlin (DE)

Correspondence Address: YOUNG & THOMPSON, 745 SOUTH 23RD STREET 2ND FLOOR, ARLINGTON, VA, 22202

(21) Appl. No.: 10/401,860

(22) Filed: Mar. 31, 2003

(30) Foreign Application Priority Data
Apr. 2, 2002 (DE) 10215319.1

(51) Int. Cl. H05B 33/00

(52) U.S. Cl. 313/501

(57) ABSTRACT

Apparatus for illuminating a sample plate (12) which is to be examined for example by fluorescent light excitation of the samples. This apparatus has a plurality of light-emitting diodes (15), which are arranged in an array and whose radiated light is guided in a homogeneous light field through an optical arrangement (19) onto a sample field (22). The intensity of the light field suffices in particular for generating a fluorescent light excitation of the samples (23), which can be determined by a CCD camera (29). This provides a cost-effective light source for generating a light field with sufficient intensity.

The invention relates to an apparatus having a light source, which is formed from a plurality of light-emitting diodes arranged next to one another, and an optical arrangement, which has at least one converging lens, and through which the light emerging from the at least one light-emitting diode is guided for the purpose of illuminating a sample plate with a plurality of samples to be examined.

Such an apparatus is disclosed for example in the published German patent application DE 199 40 752 A1. This apparatus is suitable for illuminating sample plates for the purpose of their production or else their examination. During the examination, the samples to be illuminated are illuminated by a location-specific exposure of the sample plate, the location-specific exposure being achieved by means of an exposure matrix. Said exposure matrix may be formed for example from a matrix arrangement of microdiodes, a respective microdiode corresponding to a respective sample on the sample carrier in terms of its position. This makes it possible, for example, to realize a configuration of the apparatus in accordance with FIG. 4 of the abovementioned document. In accordance with this exemplary embodiment, a microdiode array which is imaged onto the sample plate by means of optical elements, such as a lens arrangement, for example, is arranged as the exposure matrix. In this case, each microdiode illuminates one sample in a sample field to be examined.

It is an object of the invention to provide an apparatus for illuminating a sample plate to be examined by means of a multiplicity of light-emitting diodes, with which apparatus, without any additional outlay, it is possible to examine sample plates with samples in variable areal arrangement in conjunction with a comparatively high luminous efficiency of the light-emitting diodes.

According to the invention, in the case of an apparatus of the type specified in the introduction, it is provided that the light-emitting diodes are arranged so closely next to one another that, by means of the optical arrangement a single light field is generated which has a region of homogeneous light intensity for the totality of the samples to be examined. The light field may comprise electromagnetic radiation of any wavelength, provided that the radiation can be influenced by optical means. The optical arrangement may be assembled for example from lenses or diaphragms which enable the single light field to be generated. The remaining distances between the individual light-emitting diodes can be bridged e.g. by a microlens array of diverging lenses, the microlens array generating a light field with uniform light intensity.

The sample plate may be, by way of example, a microtiter plate for receiving sample liquids in appropriately fashioned depressions in the surface of the sample plate, or else a so-called biochip on which there are immobilized interactants for the addition of biochemical materials to be detected.

Although the abstract of the Japanese patent application JP 103 00 672 A discloses using light-emitting diodes for directly illuminating a sample carrier for the purpose of excitation of fluorescent dyes, no measures are taken, in accordance with this document, to ensure that the sample carrier is fully illuminated homogeneously. Moreover, the scattered light generated by the light-emitting diodes used remains unutilized for the examination of the sample carrier, as a result of which the light intensity present on the sample carrier is limited.

Furthermore, although the Japanese patent application JP 2001 083091 A discloses guiding the excitation light of a light-emitting diode array for examining samples through an optical diffusing screen in order to use the light for fully illuminating the samples homogeneously, the use of a diffusing screen for this purpose brings about an increase in the proportion of scattered light in the light emitted by the light-emitting diodes, so that an even smaller proportion of light is available for the illumination of the samples.

In the case of the apparatus according to the invention, in the region with homogeneous light intensity generated by the optical arrangement, it is advantageously possible to introduce sample plates with variable sample arrangements without necessitating modification of the apparatus. It is merely necessary to satisfy the precondition that all the samples provided on the sample plate fit into the region with homogeneous light intensity, in order that the totality of the samples can be examined.

The homogeneity of the light field generated is an essential precondition for being able to compare the measured values with respect to the individual samples among one another in terms of their light intensity. Said light intensity may advantageously be used as a measure of the concentration of sample constituents provided with fluorescent markers on the sample plate.

Furthermore, as a precondition for fluorescent light excitation, a minimum light intensity of the light field is necessary in order to excite the fluorescent dyes in a sufficient manner for luminescence. If optical examination methods other than fluorescent light excitation are chosen, for example the examination of the color of the samples, then a minimum light intensity is necessary with this examination method too, in order to generate measurement signals that can be evaluated.

The use of the optical arrangement having at least one converging lens makes it possible, on account of the optical effect of the converging lens, to concentrate the light emitted by the light-emitting diodes onto the sample region to be examined. In this case, the focal length of the optical arrangement is deliberately chosen such that the light-emitting diodes are imaged in unsharp fashion in the region of the homogeneous light intensity on the sample carrier, so that the interspaces between the light-emitting diodes are bridged by the unsharp edges of the images of the light-emitting diodes. Thus, according to the invention, the optical arrangement is not used to generate a sharp image of the light-emitting diodes, but rather to generate an intentionally unsharp image with a homogeneous light distribution and, at the same time, to utilize the effect of a converging optical arrangement to reduce the proportion of scattered light in the excitation light by converging the light.

The generation of a single light field adapted to the sample field by the light source furthermore has the essential advantage that the dimensioning of the light-emitting diodes used can be chosen as desired, since said diodes need not communicate directly with the individual samples in their orientation, as is the case in the prior art mentioned in the introduction. In particular, it is also possible to provide fewer diodes than samples, which, on the one hand, reduces the number of individual components used and thus advantageously leads to more cost-effective production of the light source; on the other hand, the progressive miniaturization of the samples is thus not limited by the minimum size that can be achieved for microdiodes.

In accordance with an advantageous refinement of the invention, the distance between the respectively adjacent light-emitting diodes is small enough that it is bridged by the radiated light of the respectively adjacent light-emitting diodes, said light in each case having an aperture angle. Aperture angle in the sense of the invention is to be understood as the aperture-governed intensity distribution of the individual light-emitting diodes, whereby the distances between the LEDs are bridged and the intensity of the light field generated for examining the samples is thus advantageously additionally smooth.

In accordance with an advantageous development of the invention, it is provided that the optical arrangement has an adjusting mechanism for altering the size of the region of homogeneous light intensity. This measure enables the region of homogeneous light intensity to be optimally adapted to the area—occupied by the samples—of the size of the sample plate. As a result of this, the light intensity of the light field can always be set as high as possible with regard to the dimensioning of the sample field, since the losses which would result from the illumination of an excessively large region can be eliminated by corresponding focusing of the light field. On the other hand, the light field may, however, also be deliberately chosen to be too large for the sample field formed by the totality of the samples, thus resulting in a cost-effective possibility for setting the light intensity in the sample field. If the maximum possible light intensity of the light field is not desired, said light intensity can thus be reduced in a targeted manner. As a result of this, the variability in the use of the apparatus is advantageously increased further.

A further variant of the invention provides for the light source to be arranged in exchangeable fashion in the apparatus. This has the advantage that the light source can be exchanged in a straightforward manner in order, for example, to use light sources with different wavelength ranges of the examination light for the sample plate. This may become necessary since, in a manner governed by their functional principle, light-emitting diodes emit light only in a narrow wavelength range which has to be selected with regard to the sample examination to be carried out. The light source can be utilized for example for a fluorescent light excitation of the specific samples on the sample carrier, in which case the fluorescent dyes must be able to be excited in the wavelength range of the light emitted by the light source. By using light sources with variable characteristics with regard to the waveband of the radiated light, a sequence of examinations of a sample plate can therefore take place in an apparatus, said sample plate having so-called fluorescent markers of variable characteristic excitation wavelength.

It is particularly advantageous if the light source has light-emitting diodes with different characteristics with regard to the wavelength range of the light to be radiated. In this case, it is possible to obviate exchanging the light source for examining the sample plate in variable wavelength ranges. The examination process can advantageously be rationalized as a result of this. In particular, the light source which intrinsically combines light-emitting diodes with variable characteristics can be used optionally to carry out an examination with light-emitting diodes having one, a plurality or all of the characteristics. In the cases in which it is not important to distinguish between different fluorescent markers for the examination result, it is thus possible for an examination to be effected simultaneously in all the wavelength ranges, as a result of which time can be saved during the examination.

The light-emitting diodes with variable characteristics may, for example, be distributed in a chessboard-like manner on the base area of the light source. It is particularly advantageous, however, if the light-emitting diodes are arranged in concentric circles, light-emitting diodes of a respective wavelength range of the light to be radiated lie in each circle and light-emitting diodes of different wavelength ranges respectively lie in adjacent circles. This arrangement has proved to be particularly advantageous since the centrosymmetrical arrangement of the light-emitting diodes of variable wavelength ranges corresponds to the optical elements of the optical arrangement, which are generally likewise formed centrosymmetrically. As a result it is possible to generate particularly homogeneous light fields, thereby advantageously minimizing the errors which occur during the comparison of the measurement results of variable samples.

In accordance with a further refinement of the invention, the light source for the apparatus according to the invention has a multiplicity of SMD-LEDs (Surface Mounted Device-Light Emitting Diode) mounted on a substrate. This is a particularly cost-effective design of the light source since SMD-LEDs are among the standard electronic components and are available for a multiplicity of wavelength ranges. A minimum possible distance between adjacent SMD-LEDs should be complied with in order that a light field that is as homogeneous as possible can be generated by the light source. On account of the aperture-governed aperture angle in the radiation characteristic of the light-emitting diodes, a homogeneous light field can be generated even when small gaps occur between the SMD-LEDs. Typical SMD-LEDs have, for example, an edge length of about 0.25 mm in the square and can be fixed on the substrate with a respective distance of 0.1 mm from the adjacent SMD-LEDs.

Furthermore, it is advantageous that the light source is formed by a few large-area light-emitting diodes. Said large-area light-emitting diodes may have edge lengths of a plurality of millimeters, whereby it is possible to improve the ratio between area proportions of the light source which are occupied by light-emitting diodes and those not occupied by light-emitting diodes, with regard to a greater homogeneity of the light source.

A further refinement of the invention provides for the light source to be formed by an OLED (Organic Light Emitting Diode). In this case, it is advantageously possible to use standard OLEDs, as have been developed for example for the display of mobile telephones. By using components provided for mass production, it is advantageously possible to reduce the manufacturing costs for the light source of the apparatus according to the invention. It goes without saying that the light source can also be formed by a single OLED, provided that an OLED of sufficient size is available.

For the light sources mentioned, including those which have light-emitting diodes with variable characteristics with regard to the wavelength range of the light to be radiated, the homogeneity of the light field that can be generated for examining the sample plate is of primary importance. As already mentioned, the aperture-governed aperture angle of the light radiated by the individual light-emitting diodes leads to a bridging of those regions of the light source in which no light-emitting diodes are provided. Furthermore, the optical arrangement can generate an additional homogenization of the light field at the image location. This can be achieved for example by virtue of the fact that the light-emitting diodes of the light source are not imaged sharply on the sample plate, rather an unsharpness of the image of the light-emitting diodes on the sample carrier is deliberately generated. As a result, the edges of the light-emitting diodes become blurred in the image thereof on the sample carrier, whereby the homogenization of the light field is improved.

Furthermore, it is advantageous if the edge region of the light source is not imaged on the sample field of the sample carrier. Specifically, the light intensity decreases somewhat in the edge region of the light source since the outer light-emitting diodes of the light source lack adjacent light-emitting diodes toward the outside, which lead to an amplification of the light intensity, as is the case in the central region of the light source.

Further details of the invention emerge from the drawing, in which

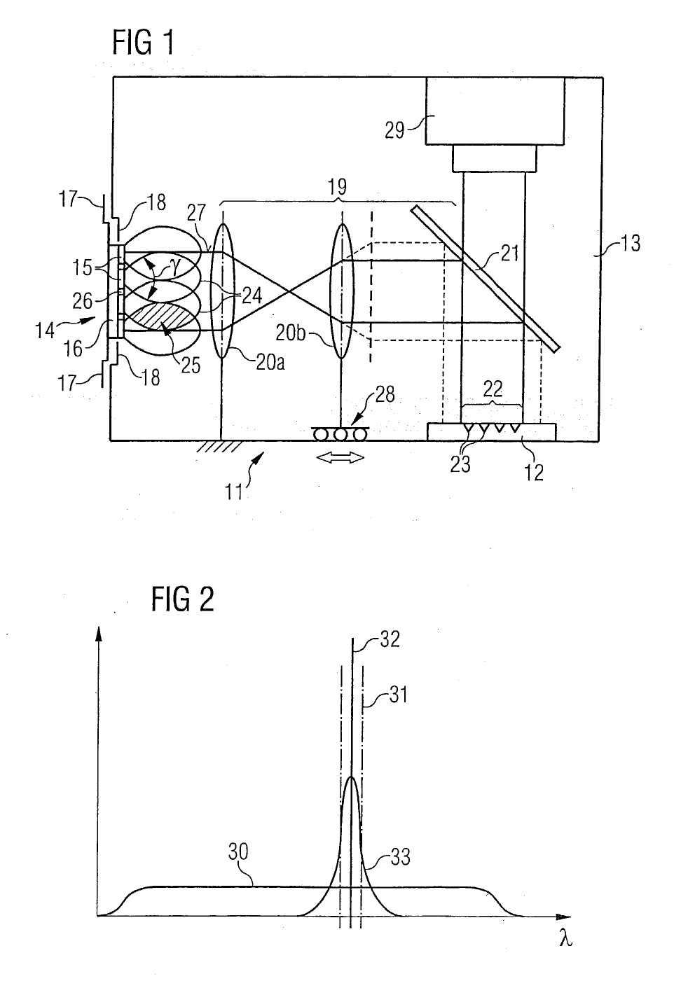

FIG. 1 shows an exemplary embodiment of the apparatus according to the invention for illuminating a sample plate to be examined, as a diagrammatic drawing,

FIG. 2 graphically shows the light intensity distribution of different light sources against the wavelength of the radiated light,

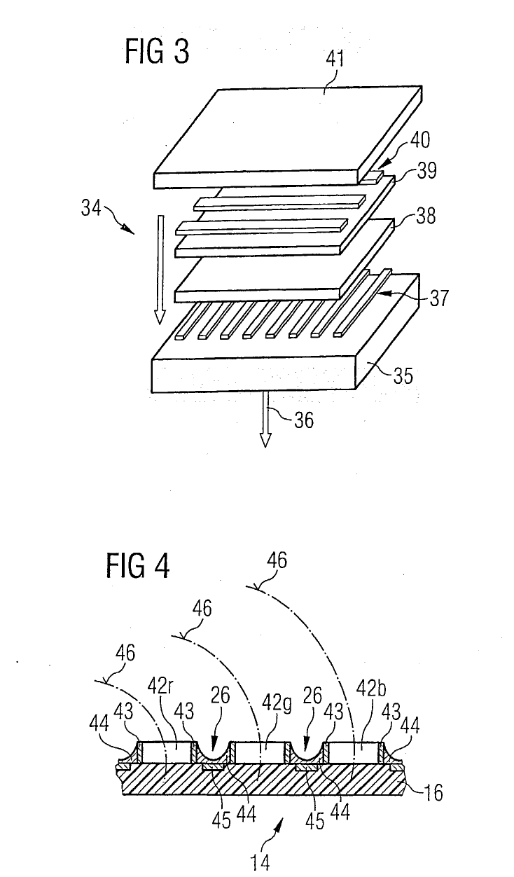

FIG. 3 diagrammatically shows the construction of an OLED as an exemplary embodiment of a light source for the apparatus according to the invention, and

FIG. 4 shows an exemplary embodiment of a light source for the apparatus according to the invention, comprising SMD-LEDs.

An apparatus 11 for examining a sample plate 12 is accommodated in a housing 13 indicated diagrammatically. The apparatus has a light source 14 formed by a multiplicity of light-emitting diodes 15. Said light-emitting diodes are fixed on a substrate 16, which has a fixing device 17 in order to be fixed in a receptacle 18 of the housing.

An optical arrangement 19 comprises converging lenses 20 a, b and a semitransparent mirror 21, the sample plate 12 being illuminated by means of the optical arrangement. The sample plate 12 has a sample field 22 formed by the sample-containing depression 23. Said sample plate is a microtiter plate; as an alternative (not illustrated), however, it is also possible to use a so-called biochip on which, by way of example, biochemical material such as DNA is hybridized by means of interactants immobilized on the sample plate. In this case, the sample plate would comprise a simple glass plate.

The beam path for illuminating the sample plate 12 will be described in more detail below. Said beam path proceeds from the light-emitting diodes 15 of the light source 14, which is arranged in a chessboard-like manner in an array of four by four diodes. The light-emitting diodes have the diagrammatically illustrated radiation characteristic 24 having an aperture-governed aperture angle γ thus resulting in an overlapping 25 of the light fields radiated by the individual light-emitting diodes 15. In this way, it is possible to bridge interspaces 26 in the array of the light-emitting diodes 15 which result from the mounting on the substrate 16. In this case, the light of the light-emitting diodes arranged at the edge of the array is only partially utilized in order to prevent a lower light intensity from being produced at the edge in the light field for examining the sample plate 12, said lower light intensity being caused by the lack of respective adjacent light-emitting diodes at the edge of the array. The usable region of the light source 14 is represented by the width of a beam path 27 indicated diagrammatically.

Said beam path runs through the converging lenses 20 a, b, the converging lens 20b being arranged in an axially displaceable manner in the optical axis of the pair of lenses. An adjusting mechanism 28 is provided for this purpose. The homogeneous light field formed by the light-emitting diodes 15 can be enlarged or reduced in size by axial displacement of the converging lens 20b. In the illustrated position of the lens 20b, the size of the light field is set optimally to the sample field 22, i.e. the maximum possible light intensity is made available for the sample field.

The sample field is illuminated via the semitransparent mirror 21, which reflects the examination light at an angle of 90°. If the light intensity of the examination light is to be reduced, then the lens 20b can be moved away from the lens 20a by axial displacement, whereby the light field is enlarged in accordance with the dashed illustration in FIG. 1. It becomes clear that only a part of the total examination light falls onto the sample field 22, whereby the intensity thereof is reduced.

The examination light excites so-called fluorescent markers (not illustrated) in the sample field, said markers indicating the presence of specific substances to be detected. The fluorescent light radiated by the fluorescent markers has a different wavelength than the examination light, which passes through the semitransparent mirror and can therefore be detected by a CCD camera 29—arranged opposite the sample plate 12—and evaluated.

If a transparent sample plate is used, it can also be examined by the transmitted light method, in a manner that is not illustrated. This means that the light of the fluorescent excitation is not projected through the semitransparent mirror counter to the direction of the examination beam path, but rather is detected by the CCD camera on the side of the sample plate opposite to the beam path (not illustrated).

FIG. 2 is a diagrammatic graphical illustration of the light intensity of different light sources as a function of the wavelength X of the light. A light distribution 30 represents the spectrum of a halogen lamp. The latter has a uniform light intensity over a relatively large wavelength range, but only a narrow wavelength range 31, represented by the dash-dotted lines, is suitable for the fluorescent light excitation. As a result, the halogen lamp power that can be utilized for the fluorescent light excitation decreases greatly. By way of example, if a 200 watt halogen lamp is used, then the power that can be utilized is only 0.04 mW given a usable wavelength range of 20 nm. Since this power has to be distributed between a multiplicity of samples on the sample plate, the power per so-called sample spot having a diameter of 30 μm decreases to an order of magnitude of 10⁻⁵ μW. Since this power is too low for fluorescent light excitation, the light has to be concentrated onto each spot by means of a microlens array in order to achieve a sufficient light intensity. Such a complicated apparatus is shown for example in the German patent application DE 197 25 050.

A light distribution 32 shows the spectrum of a laser diode which lies in the wavelength range 31 of fluorescent excitation. Said laser diode may have, for example, a power consumption of 0.05 W, a light power of one mW being able to be utilized. The latter is directed directly onto a sample spot (sequential examination), so that the latter is exposed to a generally excessively high light intensity of the order of magnitude of 500 μW. The optical power must therefore be reduced. Moreover, simultaneous excitation of all the spots requires the use of a microlaser array in accordance with German patent application 199 40 752 A1, as a result of which high costs arise in the procurement of the light source. This applies correspondingly if a microdiode array is used for the excitation, the light distribution of which array is represented by the curve 33. Instead of a number of microdiodes corresponding to the samples to be examined, however, it is also possible to use the smaller number—according to the invention—of diodes in a dense adjacent arrangement, as a result of which the light source becomes significantly more cost-effective in its production. Since the main part of the radiated light lies in the wavelength range 31 for fluorescent excitation, a comparatively large part of the generated light can be utilized. Therefore, a light power per spot of more than 3 μW can be generated through suitable division between the spots to be examined per light-emitting diode. This power is entirely sufficient for fluorescent excitation, so that the examination can be carried out by means of a cost-effective light source.

FIG. 3 illustrates an OLED 34, which can be used as a large-area light-emitting diode in the apparatus 11 in accordance with FIG. 1. In this case, division into a plurality of individual diodes is possible or an OLED covering the entire sample field 22 is used.

The OLED is applied to a glass substrate 35 through which a light emission 36 is effected. Transparent anodes 37 are applied in strip form on the glass substrate, said anodes being coated with a transport polymer 38 for the transmission of electrons. This layer is followed by a coating with an emitter polymer 39, which is responsible for the light emission. A metal cathode 40 is applied to the emitter polymer. Said metal cathode is followed by an encapsulation 41 for protecting the OLED against ambient influences.

In accordance with another variant for the light source 14, SMD-LEDs 42r, g, b are applied to the substrate 16 (cf. FIG. 1). These each have metallizations 43 serving as electrodes at two side areas. Said metallizations are electrically contact-connected to conductor tracks 45 by means of a solder material 44, thereby ensuring the electrical supply. The solder material is arranged in the interspaces 26 shown in FIG. 1. The light-emitting diode 42a emits red light, the light-emitting diode 42g emits green light and the light-emitting diode 42b emits blue light. These light-emitting diodes are arranged together with adjacent light-emitting diodes in front of and behind the plane of the drawing in each case in concentric circles 46 and can be excited by the conductor tracks 45 individually or jointly for luminescence. This makes it possible to examine the samples with variable wavelengths. Furthermore, simultaneous excitation of all the diodes makes it possible to generate a white light, which enables the samples to be examined by means of the human eye.

1. An apparatus having a light source (14), which is formed from a plurality of light-emitting diodes (15) arranged next to one another, and an optical arrangement (19), which has at least one converging lens, and through which the light emerging from the light-emitting diodes (15) is guided for the purpose of illuminating a sample plate (12) with a plurality of samples to be examined,
characterized
in that the light-emitting diodes are arranged so closely next to one another that, by means of the optical arrangement (19), a single light field is generated which has a region of homogeneous light intensity for the totality of the samples (22) to be examined.

2. The apparatus as claimed in claim 1,
characterized
in that the distance between the respectively adjacent light-emitting diodes (15) is small enough that it is bridged by the radiated light of the respectively adjacent light-emitting diodes (15), said light in each case having an aperture angle (8).

3. The apparatus as claimed in claim 1 or 2,
characterized
in that the optical arrangement has an adjusting mechanism (28) for altering the size of the region of homogeneous light intensity.

4. The apparatus as claimed in one of the preceding claims,
characterized
in that the light source (14) is arranged in exchangeable fashion in the apparatus.

5. The apparatus as claimed in one of the preceding claims,
characterized
in that the light source has light-emitting diodes (2r, g, b) with different characteristics with regard to the wavelength range of the light to be radiated.

6. The apparatus as claimed in claim 5,
characterized
in that the light-emitting diodes (2r, g, b) are arranged in concentric circles (46), light-emitting diodes of a respective wavelength range of the light to be radiated lie in each circle and light-emitting diodes of different wavelength ranges respectively lie in adjacent circles.

7. The apparatus as claimed in one of the preceding claims,
characterized
in that the light source has a multiplicity of SMD-LEDs mounted on a substrate (16).

8. The apparatus as claimed in one of claims 1 to 6,
characterized
in that the light source is formed by a few large-area light-emitting diodes.

9. The apparatus as claimed in claim 8,
characterized
in that the large-area light-emitting diodes are formed by OLEDs.
